(19) United States
(12) Patent Application Publication
(10) Pub. No.: US 2021/0129765 A1
(43) Pub. Date: May 6, 2021

(54) Secondary mirror mounting structure of vehicle rear view mirror

(71) Applicant: Kevin Huang, Tainan City (TW)

(72) Inventor: Kevin Huang, Tainan City (TW)

(21) Appl. No.: 16/873,262

(22) Filed: Mar. 9, 2020

(30) Foreign Application Priority Data
Nov. 4, 2019 (TW) 108139860

(51) Int. Cl. B60R 11/00

(52) U.S. Cl. CPC B60R 11/00; B60R 2011/0033

(57) ABSTRACT

A secondary mirror mounting structure of vehicle rearview mirror mainly comprises a mirror frame of a secondary mirror pivotally connected to a connection arm. Another end of the connection arm is upwardly extended to have an extension end toward the mirror frame. The extension end is fixedly connected with a platform. The platform and the connection arm are vertically arranged. The platform is protruded with a block edge corresponding to a mirror surface end of the secondary mirror. A protrusion direction of the block edge is vertical the platform, and extended to be back on a direction of the connection arm. A double-sided tape or glue is pasted on the platform. Afterward the platform is attached to an external edge of a mirror frame of a rearview mirror, and the block edge is regulated to buckle a front edge of the mirror frame in front of the rearview mirror. A force is applied to allow the double-sided tape or glue to be fastened with the external edge of the mirror frame. Accordingly, the secondary mirror can be easily fastened on the rearview mirror.

### BACKGROUND OF THE INVENTION

### Field of the Invention

The present invention relates to a mounting structure of a secondary mirror mounted to a vehicle rearview mirror, and more particularly to a benefit of easily and conveniently mounting a secondary mirror on a vehicle rearview mirror through configuration of the mounting structure.

### Description of the Related Art

To expand wide-angle view, a secondary mirror having a smaller area is usually added on an existing rearview mirror. A manner of mounting a conventional secondary mirror, as shown in FIG. 1, is disposed with a secondary mirror 10. The secondary mirror 10 is pivotally connected to one end of a connection arm 100. Another end of the connection arm 100 is connected to a bottom end of a primary mirror 11 so as to compose a primary-secondary mirror 1, wherein since the secondary mirror 10 is pivotally connected to the connection arm 100 so that visual angle of the secondary mirror 10 is regulated at up and down or left and right directions. An upper and lower ends of a rear surface of the primary mirror 11 are extended toward the rear direction to have an upper and lower pinch plates 12a, 12b having clamping function. The fastening of the primary-secondary mirror 1 is that a rear surface of the primary mirror 11 leans against a front surface of an existing rearview mirror 2 (the figure takes the rearview mirror inside the vehicle as an example), and the upper and lower pinch plates 12a, 12b are respectively attached to an upper edge 20 and a lower edge 21 of the rearview mirror 2. Snap ends 120a, 120b bent in vertical direction are snapped at a rear side of the rearview mirror 2 such that the primary mirror 11 is fastened and positioned at the front surface of the rearview mirror 2. Accordingly, the primary-secondary mirror 1 is mounted on the rearview mirror 2 (as shown in FIG. 2).

If the conventional rearview mirror 2 of the vehicle is required to add the secondary mirror 10, not only disposition cost of the primary mirror 11 is increased, but also the front surface of the existing rearview mirror 2 of the vehicle is covered by the primary mirror 11 (as shown in FIG. 2) and cannot be used. Consequently, the existing rearview mirror 2 of the vehicle is merely taken as a stationary support rack for the primary-secondary mirror 1.

Furthermore, although the secondary mirror 10 further has a type of locking a mirror frame of the rearview mirror 2 through screw members to fasten the secondary mirror 10 below the rearview mirror 2, in addition to drilling tools, drilling holes on the mirror frame of the rearview mirror 2 of the vehicle additionally requires technique. Normal vehicle owners may worry their mounting skill to damage the rearview mirror 2 in case of mishandled situation. Most vehicle owners would purchase the primary-secondary mirror 1 if requiring the secondary mirror 10.

### SUMMARY OF THE INVENTION

The inventor(s) thinks the problem needs to be improved and carries out deeply researches to finally create the innovate design upon long term effort.

Therefore, it is a primary objective of the present invention to provide a secondary mirror mounting structure that easily mounts a secondary mirror on an existing rearview mirror of a vehicle without affecting the existing rearview mirror's function in the vehicle.

A main characteristic of the invention is that a connection arm pivotally connected to a mirror frame top surface of the secondary mirror. An extension end outwardly extended from the connection arm is fixedly connected to a platform vertically connected to the connection arm. The platform is protruded with a block edge toward a mirror surface end of the secondary mirror. A protrusion direction of the block edge is-vertical the platform. Before the secondary mirror is-mounted to a position selected from the existing rearview mirror of the vehicle, the platform is firstly pasted with a double-sided tape or glue. Afterward, the platform is attached to an external edge of a mirror frame of the existing rearview mirror, and the block edge is regulated to buckle on a front edge of a mirror frame in front of the rearview mirror. Accordingly, the secondary mirror can be easily and fastened on the rearview mirror.

The technical characteristics, contents, advantages and effects of the present invention will be apparent with the detailed description accompanied with related drawings of two preferred embodiments as follows.

### BRIEF DESCRIPTION OF THE DRAWINGS

FIG. 1 is a side decomposition drawing of a conventional primary-secondary mirror and vehicle existing rearview mirror;

FIG. 2 is an assembled drawing of a conventional primary-secondary mirror and vehicle existing rearview mirror;

FIG. 3 is a three-dimensional drawing of an example mirror according to the embodiment of the invention;

FIG. 4 is a three-dimensional drawing from another angle of the example mirror according to the embodiment of the invention;

FIG. 5 is a decomposition drawing according to FIG. 3;

FIG. 6 is a decomposition drawing according to FIG. 4;

FIG. 7 is a cross-sectional drawing of the example mirror according to the embodiment of the invention;

FIG. 8 is an assembled drawing of the example mirror mounted to a rearview mirror inside the vehicle according to the embodiment of the invention;

FIG. 9 is a decomposition drawing according to FIG. 8;

FIG. 10 is a cross-sectional drawing according to FIG. 8;

FIG. 11 is a three-dimensional drawing of the example mirror mounted to rearview mirrors outside the vehicle according to the embodiment of the invention; and

FIG. 12 is a decomposition drawing according to FIG. 11.

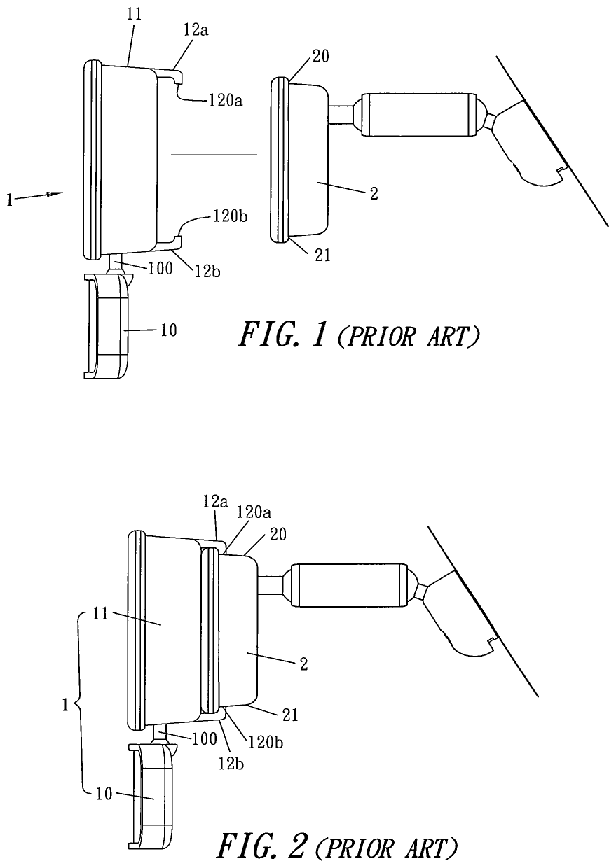

### DETAILED DESCRIPTION OF THE PREFERRED EMBODIMENTS

The technical characteristics, contents, advantages and effects of the present invention will be apparent with the detailed description accompanied with related drawings of preferred embodiments as follows.

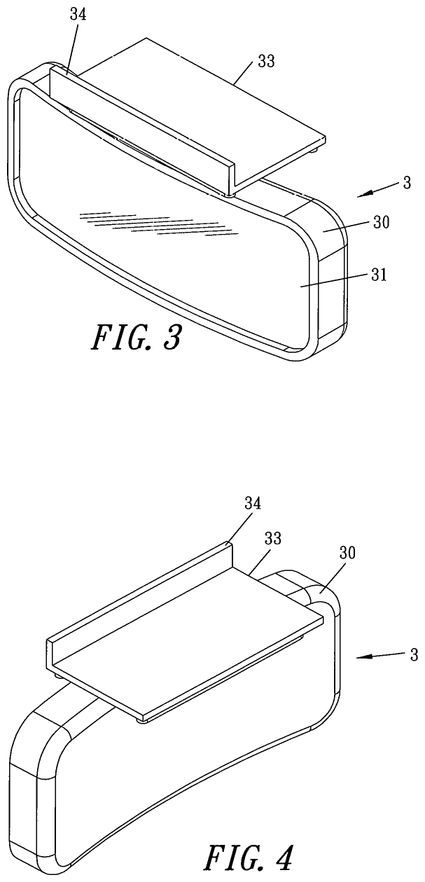

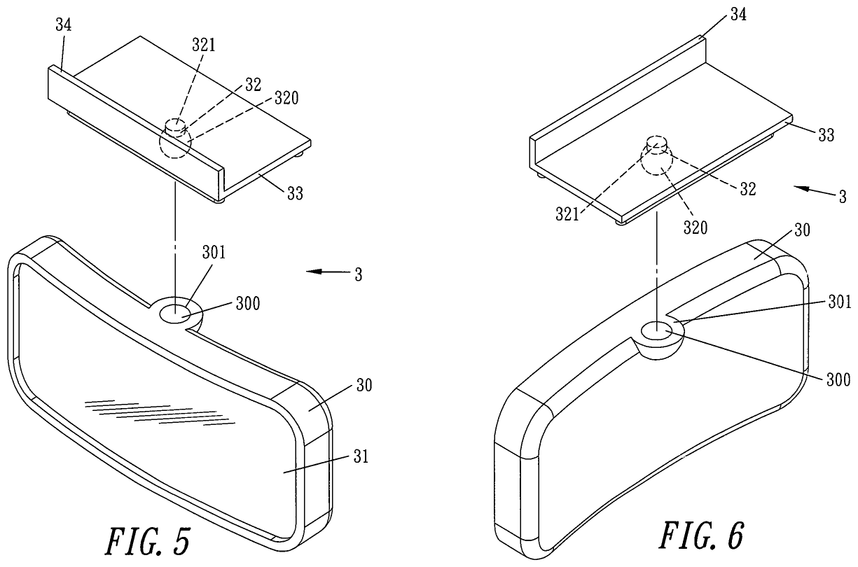

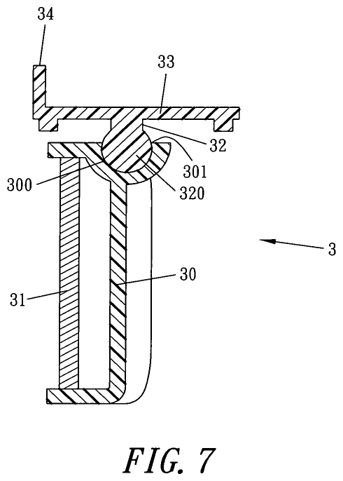

With reference to FIGS. 3˜7, a secondary mirror 3 according to the embodiment of the invention comprises a mirror frame 30. A mirror surface 31 is inserted to a mirror frame opening of the mirror frame 30. One end of a connection arm 32 has a sphere 320 (as shown in FIGS. 5˜7). The sphere 320 is inserted to a concave hole 300 disposed on a top surface of the mirror frame 30 to achieve pivot connection. A diameter of a hole opening 301 is slightly smaller than the maximum diameter of inner hole of the concave hole 300, and a circle diameter of the sphere 320 is equivalent to an internal diameter of the concave hole 300 so that the sphere 320 does not easily come off the concave hole 300. Another end of the connection arm 32 is outwardly extended to have an extension end 321. A main improvement of the invention is that:

A length of the extension end 321 of the connection arm 32 exceeds the mirror frame 30 to fixedly connect a platform 33. The platform 33 is vertically arranged with the connection arm 32. The platform 33 is protruded with a block edge 34 corresponding to the mirror surface 31 of the secondary mirror 3. A protrusion direction of the block edge 34 is vertical the platform 3 and extended to be back on a direction of the connection arm 32.

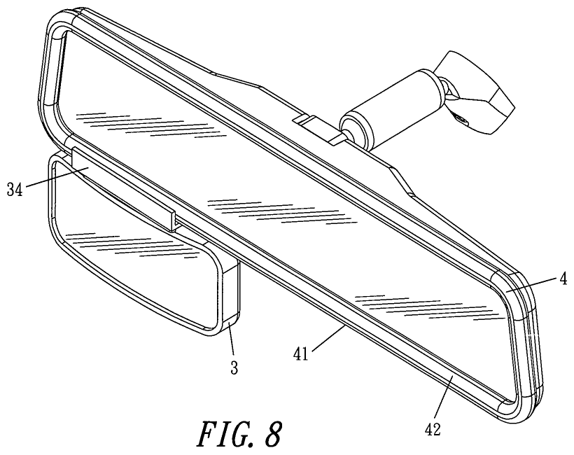

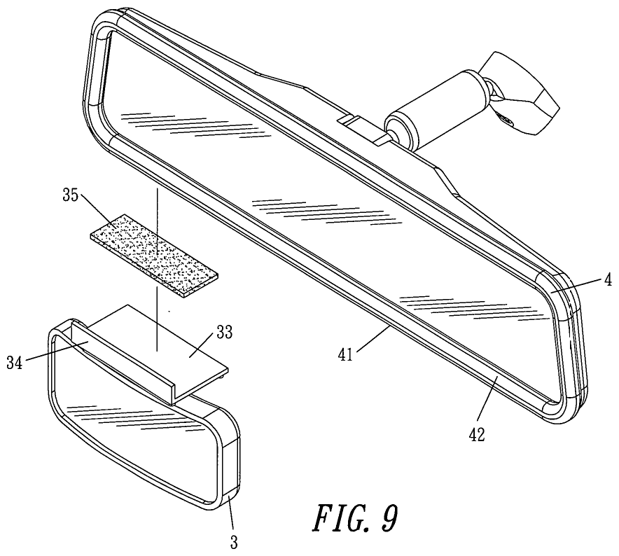

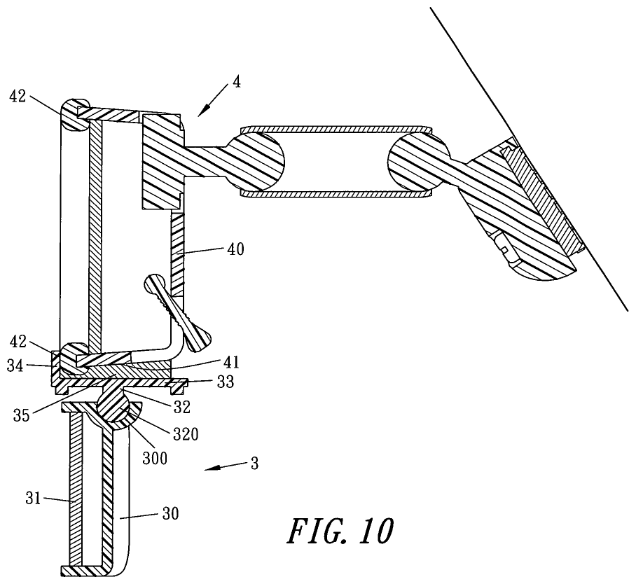

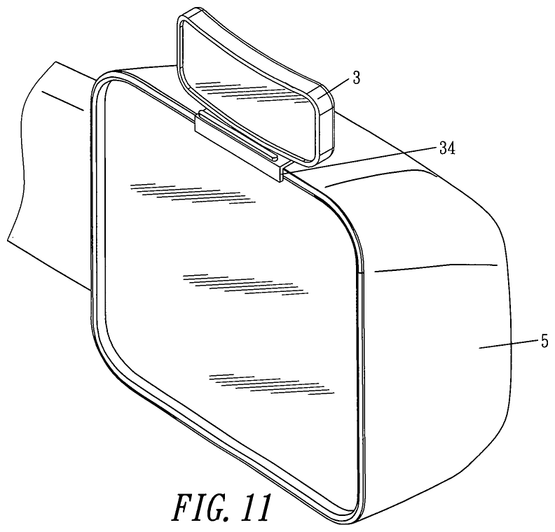

When the secondary mirror 3 is mounted to a rearview mirror 34 inside a vehicle, the platform 33 is first pasted with a double-sided tape 35 or glue. Afterward the platform 33 is attached to an external edge 41 of a mirror frame 40 of the rearview mirror 4 inside the vehicle, and the block edge 34 is regulated to be buckled to a front edge 42 of the mirror frame 40 in front of the rearview mirror 4. The double-sided tape 45 or glue on the platform 33 is imposed with force to fix an external edge 41 of the mirror frame 40 of the rearview mirror 4 in the vehicle so that the secondary mirror 3 can be easily fastened on the rearview mirror 4 as shown in FIGS. 8, 9, 10.

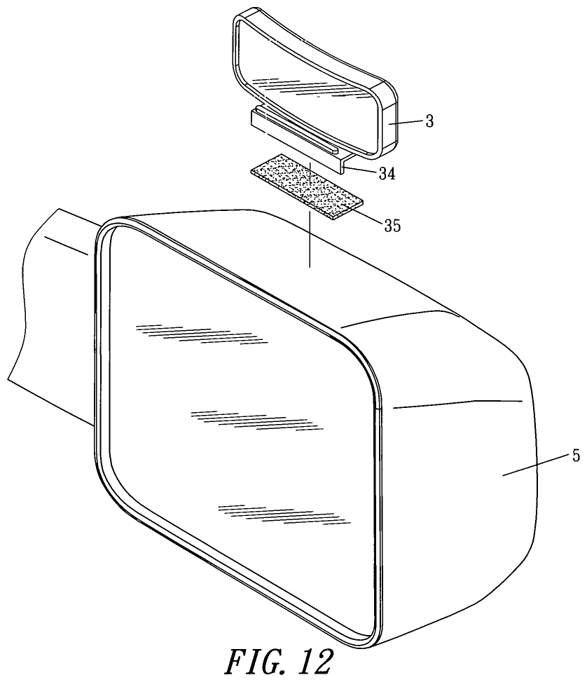

The secondary mirror 3 can be fastened on the rearview mirror 4 in the vehicle. In addition, it can also be fastened on a rearview mirrors 5 outside the vehicle as shown in FIGS. 11, 12. The mounting manner is depicted as stated above.

Therefore, the application does not need to use primary secondary mirror mode or rely on drilling tools incorporated with screw members. The secondary mirror can be easily fastened on the rearview mirror. Moreover, since the whole area of the platform 33 is entirely glued with the external edge 41 of the mirror frame 40 of the rearview mirror 4, and the block edge 34 is buckled to the front edge 42 of the mirror frame 40 in front of the rearview mirror 4, the secondary mirror 3 can be extremely and steadily fastened to the rearview mirror 4.

While the present invention has been described by means of specific embodiments, numerous modifications and variations could be made thereto by those skilled in the art without departing from the scope and spirit of the invention set forth in the claims.

What is claimed is:

1. A secondary mirror mounting structure of a vehicle rearview mirror, a secondary mirror having a mirror frame and a mirror surface inserted to the mirror frame, the mirror frame pivotally connected to a connection arm, another end of the connection arm upwardly extended to have an extension end, a length of the extension end exceeding the mirror frame and fixedly connected to a platform, the platform and the connection arm vertically configured; the platform protruded with a block edge corresponding to the mirror surface end of the secondary mirror, the block edge being vertical the platform in a protrusion direction and extended to be back on a direction of the connection arm.

2. The secondary mirror mounting structure of the vehicle rearview mirror of claim 1, wherein the connection arm pivotally connected to the mirror frame is that the connection arm has a sphere at a pivot connection end, and the sphere is inserted into a concave hole disposed on a top surface of the mirror frame, and a hole diameter of the concave hole is smaller than a maximum diameter of inner hole of the concave hole, and a circle diameter of the sphere is equivalent to an inner diameter of the concave hole so that the sphere is inserted into the concave hole and difficult to detach.

3. The secondary mirror mounting structure of the vehicle rearview mirror of claim 1, wherein the platform is pasted with a double-sided tape or glue, and the platform is attached to an external edge of the mirror frame of the rearview mirror, and the block edge is regulated to buckle a front edge in front of the mirror frame of the rearview mirror, and the double-sided tape or glue on the platform is implied with force to glue and fasten an external edge of the mirror frame of the rearview mirror so that the secondary mirror is fastened to the rearview mirror.
